(19) United States
(12) Patent Application Publication
(10) Pub. No.: US 2007/0028098 A1
(43) Pub. Date: Feb. 1, 2007

(54) Encrypting units of work based on a trust level

(75) Inventors: Randall Paul Baartman, Rochester, MN (US); Steven Joseph Branda, Rochester, MN (US); Surya V. Duggirala, Eagan, MN (US); John Joseph Stecher, Rochester, MN (US); Robert Wisniewski, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(73) Assignee: INTERNATIONAL BUSINESS MACHINES CORPORATION, ARMONK, NY (US)

(21) Appl. No.: 11/191,404

(22) Filed: Jul. 28, 2005

(51) Int. Cl. H04L 9/00

(52) U.S. Cl. 713/162

(57) ABSTRACT

A method, apparatus, system, and signal-bearing medium that, in an embodiment, determine a cipher strength based on a trust level associated with a request, create a unit of work based on the request, encrypt the unit of work into a message based on the cipher strength, and send the message to grid servers. In various embodiments, the trust level may be determined based on a security token associated with the request or based on a zone from which the request originates. In various embodiments, the request originates from a client that belongs to the zone or originates from one of the grid servers that belongs to the zone. In an embodiment, a request from a grid server may be associated with a response to a previous unit of work that the grid server executed.

### FIELD

This invention generally relates to grid computer systems and more specifically relates to encrypting units of work based on a trust level of a zone.

### BACKGROUND

The development of the EDVAC computer system of 1948 is often cited as the beginning of the computer era. Since that time, computer systems have evolved into extremely sophisticated devices, and computer systems may be found in many different settings. Computer systems typically include a combination of hardware, such as semiconductors and circuit boards, and software, also known as computer programs.

Years ago, computer systems were stand-alone devices that did not communicate with each other. But today, computers are increasingly connected via networks, such as the Internet. When connected via a network, one computer, often called a client, may request services from another computer, often called a server. In addition to the Internet example above, companies often have internal networks that connect their various computers together. A large company with hundreds of thousands of employees may have hundreds of thousands of computers all connected via a network. Many of these computers are idle for much of the time. For example, typical office workers have computers on their desks, which they use for a few hours each day to check e-mail, compose documents, or request services from a server computer. The rest of the day, the office worker spends on the telephone, in meetings, or at home while the computer sits unused and idle. Thus, many companies have hundreds of millions of dollars invested in computers that are underutilized.

These companies would naturally like to find a way to use this vast and underutilized, but widely distributed, computer capacity. One technique for using idle computer capacity is called grid computing. In grid computing, a grid controller breaks up a task at one computer into multiple, smaller units of work (UOW). The grid controller sends each unit of work to multiple receiving grid servers in parallel via a network. Some of these grid servers execute the unit of work and send the results back quickly. Other of the grid servers computers execute the unit of work and send the results back more slowly. Still others never receive the unit of work, receive the unit of work but never execute it, or execute the unit of work but never send the results back. The grid controller uses the first results that are returned for a particular unit of work and ignores the other, later results. In addition to the benefit of saving money by using underutilized computer resources, grid computing also has the advantage of performance benefits, by breaking up a large task into many smaller units of work and executing them in parallel.

Although grid computing can have many advantages, grid computing also has difficulties that need to be managed. For example, a grid computing environment often includes diverse and dissimilar grid servers that need to be shared and coordinated, not only efficiently, but also in a secure manner. One security implementation is the Secure Sockets Layer (SSL) and the follow-on Internet standard of SSL known as Transport Layer Security (TLS). Two important SSL concepts are the SSL session and the SSL connection. An SSL connection is a logical client/server link between nodes in a network. The connections are transient, and every connection is associated with one session. An SSL session is an association between a client and a server. Sessions are created by the SSL Handshake Protocol.

The SSL Handshake Protocol is used before any application data is transmitted between the client and server. The SSL Handshake Protocol consists of a series of messages exchanged between the client and the server and allows them to authenticate each other and to negotiate which cipher suite they will use when transmitting messages. A cipher suite is a set of authentication, data integrity, and encryption algorithms used for exchanging messages between network nodes.

The encryption algorithm uses a “key” to encrypt and decrypt data. The data is encrypted, or “locked,” at the sending node by combining the bits in the key mathematically with the data bits. At the receiving node, the key is used to “unlock” the encryption and restore the original data. The key is a binary number that is typically from 40 to 256 bits in length, and the number of bits in the key is referred to as the cipher strength. The greater the cipher strength, the more possible key combinations and thus the more time an unauthorized program would need to break the encryption and discover the original data.

But, in the current security model typically used in grid computing, the cipher strength of the SSL connection is predetermined at the time of the handshake and does not vary between requests or between nodes in the network. As the processing overhead of a SSL connection is mainly dependent on the cipher strength, with stronger cipher strength requiring more processing time, the performance of the SSL connections depends heavily on the cipher strength. Thus, requests that do not require a high cipher strength use a high cipher strength, nonetheless, and are penalized via lower performance and increased response time.

Thus, a better technique is needed for determining cipher strength for data in a network.

### SUMMARY

A method, apparatus, system, and signal-bearing medium are provided that, in an embodiment, determine a cipher strength based on a trust level associated with a request, create a unit of work based on the request, encrypt the unit of work into a message based on the cipher strength, and send the message to grid servers. In various embodiments, the trust level may be determined based on a security token associated with the request or based on a zone from which the request originates. In various embodiments, the request originates from a client that belongs to the zone or originates from one of the grid servers that belongs to the zone. In an embodiment, a request from a grid server may be associated with a response to a previous unit of work that the grid server executed.

### BRIEF DESCRIPTION OF THE DRAWINGS

Various embodiments of the present invention are hereinafter described in conjunction with the appended drawings:

FIG. 1 depicts a high-level block diagram of an example system for implementing an embodiment of the invention.

FIG. 2 depicts a block diagram of selected components of the example system, according to an embodiment of the invention.

FIG. 3 depicts a flowchart of processing, according to an embodiment of the invention.

It is to be noted, however, that the appended drawings illustrate only example embodiments of the invention, and are therefore not considered limiting of its scope, for the invention may admit to other equally effective embodiments.

### DETAILED DESCRIPTION

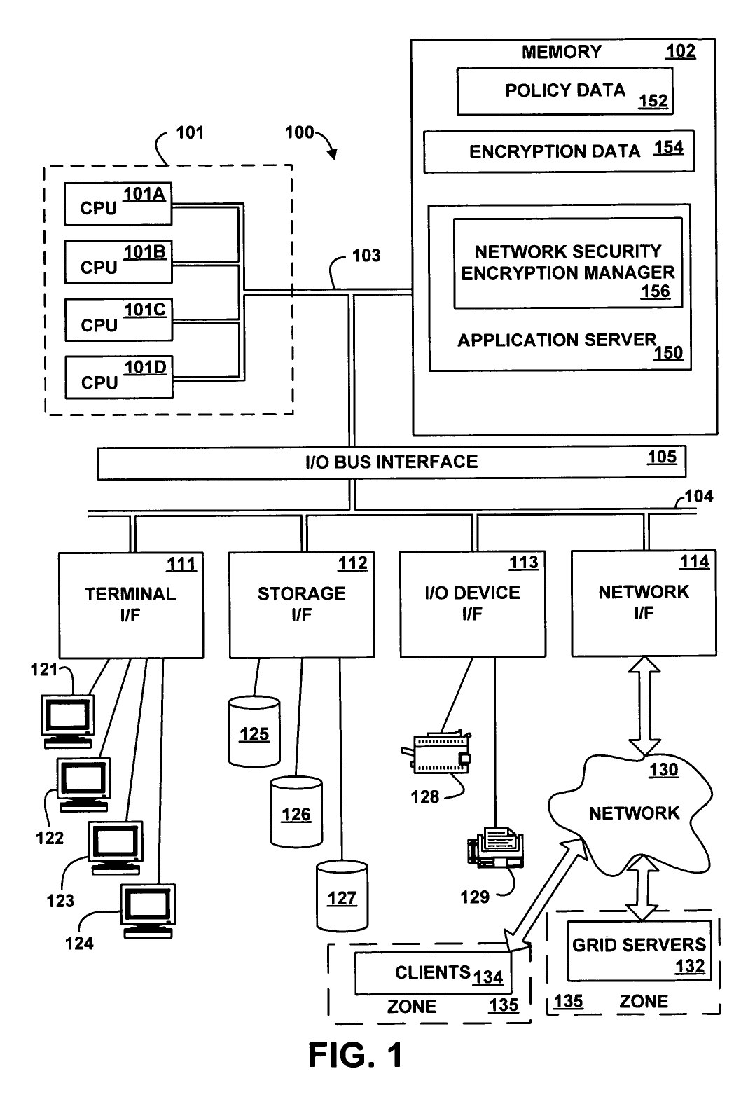

Referring to the Drawings, wherein like numbers denote like parts throughout the several views, FIG. 1 depicts a high-level block diagram representation of a computer system 100 connected via a network 130 to grid servers 132 and clients 134, according to an embodiment of the present invention. The grid servers 132 and the clients 134 are organized into zones 135. In an embodiment, the hardware components of the computer system 100 may be implemented by an eServer iSeries computer system available from International Business Machines of Armonk, N.Y. However, those skilled in the art will appreciate that the mechanisms and apparatus of embodiments of the present invention apply equally to any appropriate computing system. The terms “computer system,” “client,” and “server” are used for convenience only, and in other embodiments any appropriate electronic devices may be used, and a device that acts as a client in one scenario may act as a server in another scenario, and vice versa.

The major components of the computer system 100 include one or more processors 101, a main memory 102, a terminal interface 111, a storage interface 112, an I/O (Input/Output) device interface 113, and communications/network interfaces 114, all of which are coupled for inter-component communication via a memory bus 103, an I/O bus 104, and an I/O bus interface unit 105.

The computer system 100 contains one or more general-purpose programmable central processing units (CPUs) 101A, 101B, 101C, and 101D, herein generically referred to as the processor 101. In an embodiment, the computer system 100 contains multiple processors typical of a relatively large system; however, in another embodiment the computer system 100 may alternatively be a single CPU system. Each processor 101 executes instructions stored in the main memory 102 and may include one or more levels of on-board cache.

The main memory 102 is a random-access semiconductor memory for storing data and programs. In another embodiment, the main memory 102 represents the entire virtual memory of the computer system 100, and may also include the virtual memory of other computer systems coupled to the computer system 100 or connected via the network 130. The main memory 102 is conceptually a single monolithic entity, but in other embodiments the main memory 102 is a more complex arrangement, such as a hierarchy of caches and other memory devices. For example, the main memory 102 may exist in multiple levels of caches, and these caches may be further divided by function, so that one cache holds instructions while another holds non-instruction data, which is used by the processor or processors. The main memory 102 may be further distributed and associated with different CPUs or sets of CPUs, as is known in any of various so-called non-uniform memory access (NUMA) computer architectures.

The main memory 102 includes an application server 150, policy data 152, and encryption data 154. Although the application server 150, the policy data 152, and the encryption data 154 are illustrated as being contained within the memory 102 in the computer system 100, in other embodiments some or all of them may be on different computer systems and may be accessed remotely, e.g., via the network 130. The computer system 100 may use virtual addressing mechanisms that allow the programs of the computer system 100 to behave as if they only have access to a large, single storage entity instead of access to multiple, smaller storage entities. Thus, while the application server 150, the policy data 152, and the encryption data 154 are illustrated as being contained within the main memory 102, these elements are not necessarily all completely contained in the same storage device at the same time. Further, although the application server 150, the policy data 152, and the encryption data 154 are illustrated as being separate entities, in other embodiments some of them, or portions of some of them, may be packaged together.

The application server receives requests from the clients 134, breaks up the requests into units of work and sends the units of work to the grid servers 132 for execution. The application server 150 includes a network security encryption manager 156. The network security encryption manager 156 encrypts the units of work prior to the application server 150 sending them to the grid servers 132.

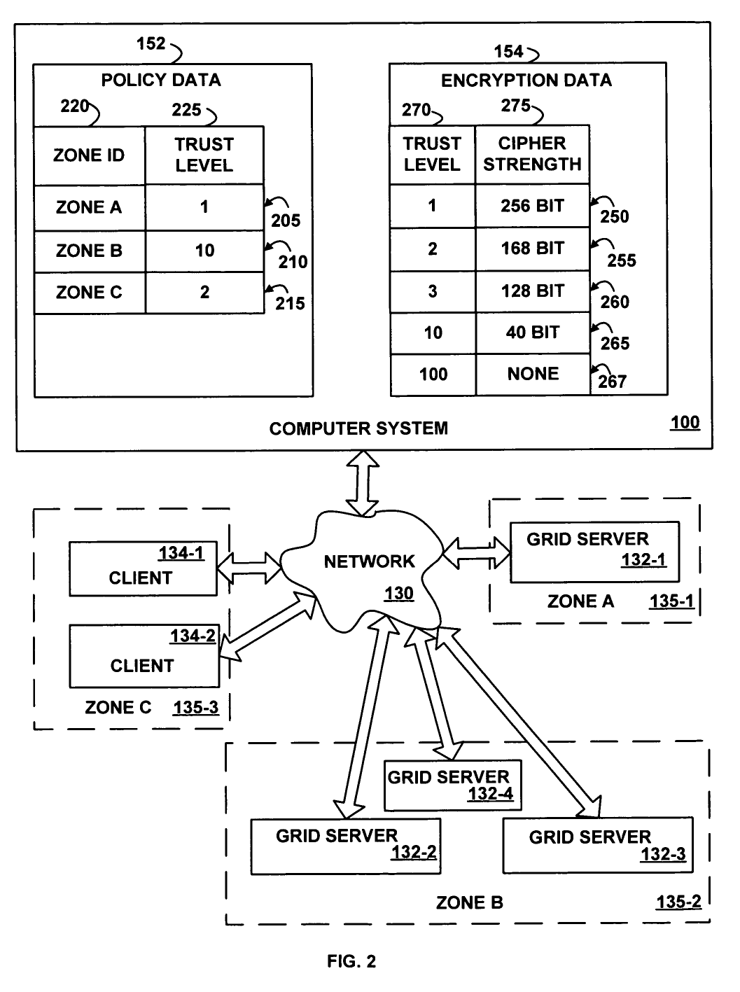

The policy data 152 indicates the trust level of the zones 135 into which the grid servers 132 and the clients 134 are organized. The policy data 152 is further described below with reference to FIG. 2. The encryption data 154 indicates the cipher strength associated with the trust levels. The encryption data 154 is further described below with reference to FIG. 2.

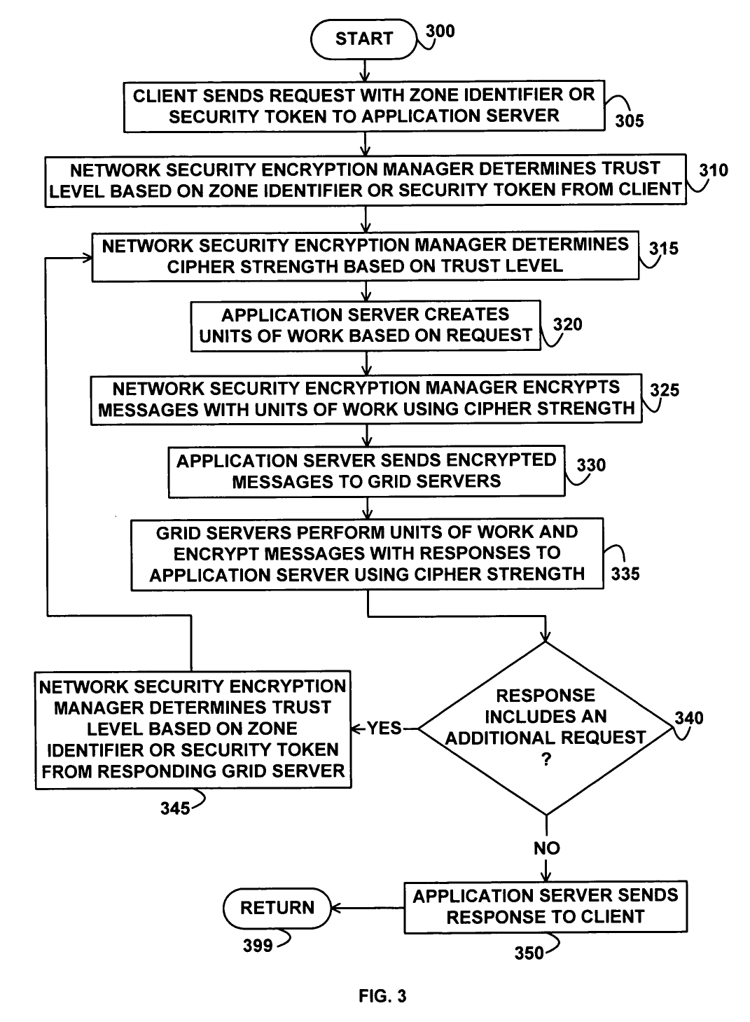

In an embodiment, the network security encryption manager 156 includes instructions capable of executing on the processor 101 or statements capable of being interpreted by instructions executing on the processor 101 to perform the functions as further described below with reference to FIG. 3. In another embodiment, the network security encryption manager 156 may be implemented in microcode. In another embodiment, the network security encryption manager 156 may be implemented in hardware via logic gates and/or other appropriate hardware techniques in lieu of or in addition to a processor-based system.

The memory bus 103 provides a data communication path for transferring data among the processor 101, the main memory 102, and the I/O bus interface unit 105. The I/O bus interface unit 105 is further coupled to the system I/O bus 104 for transferring data to and from the various I/O units. The I/O bus interface unit 105 communicates with multiple I/O interface units 111, 112, 113, and 114, which are also known as I/O processors (IOPs) or I/O adapters (IOAs), through the system I/O bus 104. The system I/O bus 104 may be, e.g., an industry standard PCI bus, or any other appropriate bus technology.

The I/O interface units support communication with a variety of storage and I/O devices. For example, the terminal interface unit 111 supports the attachment of one or more user terminals 121, 122, 123, and 124. The storage interface unit 112 supports the attachment of one or more direct access storage devices (DASD) 125, 126, and 127 (which are typically rotating magnetic disk drive storage devices, although they could alternatively be other devices, including arrays of disk drives configured to appear as a single large storage device to a host). The contents of the main memory 102 may be stored to and retrieved from the direct access storage devices 125, 126, and 127, as needed.

The I/O and other device interface 113 provides an interface to any of various other input/output devices or devices of other types. Two such devices, the printer 128 and the fax machine 129, are shown in the exemplary embodiment of FIG. 1, but in other embodiment many other such devices may exist, which may be of differing types. The network interface 114 provides one or more communications paths from the computer system 100 to other digital devices and computer systems; such paths may include, e.g., one or more networks 130.

Although the memory bus 103 is shown in FIG. 1 as a relatively simple, single bus structure providing a direct communication path among the processors 101, the main memory 102, and the I/O bus interface 105, in fact the memory bus 103 may comprise multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 105 and the I/O bus 104 are shown as single respective units, the computer system 100 may in fact contain multiple I/O bus interface units 105 and/or multiple I/O buses 104. While multiple I/O interface units are shown, which separate the system I/O bus 104 from various communications paths running to the various I/O devices, in other embodiments some or all of the I/O devices are connected directly to one or more system I/O buses.

The computer system 100 depicted in FIG. 1 has multiple attached terminals 121, 122, 123, and 124, such as might be typical of a multi-user “mainframe” computer system. Typically, in such a case the actual number of attached devices is greater than those shown in FIG. 1, although the present invention is not limited to systems of any particular size. The computer system 100 may alternatively be a single-user system, typically containing only a single user display and keyboard input, or might be a server or similar device which has little or no direct user interface, but receives requests from other computer systems (clients). In other embodiments, the computer system 100 may be implemented as a personal computer, portable computer, laptop or notebook computer, PDA (Personal Digital Assistant), tablet computer, pocket computer, telephone, pager, automobile, teleconferencing system, appliance, or any other appropriate type of electronic device.

The network 130 may be any suitable network or combination of networks and may support any appropriate protocol suitable for communication of data and/or code to/from the computer system 100. In various embodiments, the network 130 may represent a storage device or a combination of storage devices, either connected directly or indirectly to the computer system 100. In an embodiment, the network 130 may support Infiniband. In another embodiment, the network 130 may support wireless communications. In another embodiment, the network 130 may support hard-wired communications, such as a telephone line or cable. In another embodiment, the network 130 may support the Ethernet IEEE (Institute of Electrical and Electronics Engineers) 802.3x specification. In another embodiment, the network 130 may be the Internet and may support IP (Internet Protocol).

In another embodiment, the network 130 may be a local area network (LAN) or a wide area network (WAN). In another embodiment, the network 130 may be a hotspot service provider network. In another embodiment, the network 130 may be an intranet. In another embodiment, the network 130 may be a GPRS (General Packet Radio Service) network. In another embodiment, the network 130 may be a FRS (Family Radio Service) network. In another embodiment, the network 130 may be any appropriate cellular data network or cell-based radio network technology. In another embodiment, the network 130 may be an IEEE 802.11B wireless network. In still another embodiment, the network 130 may be any suitable network or combination of networks. Although one network 130 is shown, in other embodiments any number (including zero) of networks (of the same or different types) may be present.

The grid servers 132 may include some or all of the hardware and/or software components already described for the computer system 100. The grid servers 132 may be organized into zones 135, as further described below with reference to FIG. 2. The grid servers 132 perform units of work received from the application server 150, as further described below with reference to FIG. 3. Although the servers 132 are illustrated as separate from the computer system 100, in other embodiments, some or all of the servers 132 may be a part of the computer system 100, e.g., implemented as applications executing in the computer system 100.

The clients 134 may include some or all of the hardware and/or software components already described for the computer system 100. The clients 134 are organized into zones 135, as further described below with reference to FIG. 2. The clients 134 send requests to the application server 150, as further described below with reference to FIG. 3. Although the clients 134 are illustrated as separate from the computer system 100, in other embodiments, some or all of the clients 134 may be a part of the computer system 100, e.g., implemented as applications executing in the computer system 100.

It should be understood that FIG. 1 is intended to depict the representative major components of the computer system 100, the network 130, the servers 132, and the clients 134 at a high level, that individual components may have greater complexity than represented in FIG. 1, that components other than or in addition to those shown in FIG. 1 may be present, and that the number, type, and configuration of such components may vary. Several particular examples of such additional complexity or additional variations are disclosed herein; it being understood that these are by way of example only and are not necessarily the only such variations.

The various software components illustrated in FIG. 1 and implementing various embodiments of the invention may be implemented in a number of manners, including using various computer software applications, routines, components, programs, objects, modules, data structures, etc., referred to hereinafter as “computer programs,” or simply “programs.” The computer programs typically comprise one or more instructions that are resident at various times in various memory and storage devices in the computer system 100, and that, when read and executed by one or more processors 101 in the computer system 100, cause the computer system 100 to perform the steps necessary to execute steps or elements comprising the various aspects of an embodiment of the invention.

Moreover, while embodiments of the invention have and hereinafter will be described in the context of fully-functioning computer systems, the various embodiments of the invention are capable of being distributed as a program product in a variety of forms, and the invention applies equally regardless of the particular type of signal-bearing medium used to actually carry out the distribution. The programs defining the functions of this embodiment may be stored in, encoded on, and delivered to the computer system 100 via a variety of tangible signal-bearing media, which include, but are not limited to the following computer-readable media:

(1) information permanently stored on a non-rewriteable storage medium, e.g., a read-only memory or storage device attached to or within a computer system, such as a CD-ROM, DVD-R, or DVD+R;

(2) alterable information stored on a rewriteable storage medium, e.g., a hard disk drive (e.g., the DASD 125, 126, or 127), CD-RW, DVD-RW, DVD+RW, DVD-RAM, or diskette; or

(3) information conveyed by a communications or transmission medium, such as through a computer or a telephone network, e.g., the network 130.

Such tangible signal-bearing media, when carrying or encoded with computer-readable, processor-readable, or machine-readable instructions or statements that direct or control the functions of the present invention, represent embodiments of the present invention.

Embodiments of the present invention may also be delivered as part of a service engagement with a client corporation, nonprofit organization, government entity, internal organizational structure, or the like. Aspects of these embodiments may include configuring a computer system to perform, and deploying software systems and web services that implement, some or all of the methods described herein. Aspects of these embodiments may also include analyzing the client company, creating recommendations responsive to the analysis, generating software to implement portions of the recommendations, integrating the software into existing processes and infrastructure, metering use of the methods and systems described herein, allocating expenses to users, and billing users for their use of these methods and systems.

In addition, various programs described hereinafter may be identified based upon the application for which they are implemented in a specific embodiment of the invention. But, any particular program nomenclature that follows is used merely for convenience, and thus embodiments of the invention should not be limited to use solely in any specific application identified and/or implied by such nomenclature.

The exemplary environments illustrated in FIG. 1 are not intended to limit the present invention. Indeed, other alternative hardware and/or software environments may be used without departing from the scope of the invention.

FIG. 2 depicts a block diagram of selected components of the example system, according to an embodiment of the invention. In the example illustrated system, the computer system 100 is connected to grid servers 132-1, 132-2, 132-3, and 132-4 and clients 134-1 and 134-2 via the network 130. Each of the servers 132-1, 132-2, 132-3, 132-4 is an example of the server 132, as previously described above with reference to FIG. 1. Each of the clients 134-1 and 134-2 is an example of the client 134 as previously described above with reference to FIG. 1.

The grid servers 132 and the clients 134 are organized into zones, such as the zone A 135-1, the zone B 135-2, and the zone C 135-3, which are generically referred to as the zones 135 (FIG. 1). The zone A 135-1 includes the grid server 132-1, the zone B 135-2 includes the grid servers 132-2, 132-3, and 132-4, and the zone C 135-3 includes the clients 134-1 and 134-2, but in other embodiments any zone 135 may include any number and combination of the grid servers 132 and/or the clients 134.

The computer system 100 includes the policy data 152, which includes example records 205, 210, and 215, but in other embodiments any number of records with any appropriate data may be present. Each of the example records 205, 210, and 215 includes a zone identifier field 220 and a trust level field 225, but in other embodiments more or fewer fields may be present. The zone identifier field 220 indicates one or more of the zones 135 to which the grid servers 132 and/or the clients 134 may belong, such as the zones 135-1, 135-2, and 135-3.

The trust level field 225 indicates the relative level or degree to which the zone 135 indicated by the associated zone identifier 220 is trusted to be safe from security breaches. For example, a zone that includes grid servers 132 and/or clients 134 that are in the same room as the computer 100 and are connected to the computer 100 via a dedicated cable may have a relative high trust level 225 while a zone that includes grid servers 132 and/or clients 134 that are thousands of miles away from the computer 100 and are connected to the computer 100 via wireless connections may have a relative low trust level. But, any appropriate zones and trust levels may be used in the policy data 152.

The computer system 100 includes the encryption data 154, which includes example records 250, 255, 260, 265, and 267 but in other embodiments any number of records with any appropriate data may be present. Each of the example records 250, 255, 260, 265, and 267 includes a trust level field 270 and a cipher strength field 275. The trust level field 270 indicates the possible values that may exist in the trust level 225 in the policy data 152. The cipher strength field 275 indicates the encryption level associated with the trust level 270, with lower trust levels 270 having higher cipher strengths 275, and vice versa. In the example illustrated, the cipher strength 275 includes the number of bits present in the key used during encryption, but in other embodiments any appropriate cipher strength may be used. In various embodiments, the key used in the encryption algorithm may be a secret key, a public key, a two-part key, or any other appropriate type of key. In various embodiments, the encryption algorithm may be DES (Data Encryption Standard), AES (Advanced Encryption Standard), RSA (Rivest, Shamir, and Adelman), ElGamal, a combination of algorithms, or any other appropriate algorithm.

FIG. 3 depicts a flowchart of processing, according to an embodiment of the invention. Control begins at block 300. Control then continues to block 305 where the client 134 sends a request to the application server 150. The request includes an associated zone identifier, which identifies a zone 135 to which the client 134 belongs. In another embodiment, the network security encryption manager 156 determines the zone identifier based on an identification of the client. In another embodiment, the client 134 sends a request with a security token, which identifies the level of security that the client 134 and the connection provides from unauthorized access, to the application server 150.

Control then continues to block 310 where the network security encryption manager 156 determines the trust level 225 based on the zone identifier or security token associated with a request or associated with the client that originates the request. For example, the network security encryption manager 156 uses the received zone identifier to access the policy data 152 via the zone identifier field 220 and find the record with the corresponding associated trust level 225. In another embodiment, the network security encryption manager 156 performs a manipulation, for example a mathematical algorithm, on the security token to obtain the trust level.

Control then continues to block 315 where the network security encryption manager 156 determines a cipher strength based on the trust level associated with the request, the client, or the zone. In an embodiment, the network security encryption manager 156 determines the cipher strength by using the previously determined trust level to access the encryption data 154 via the trust level 270 and find the record with the corresponding associated cipher strength 275.

Control then continues to block 320 where the application server 150 creates one or more units of work based on the request. Control then continues to block 325 where the network security encryption manager 156 encrypts the units of work into messages based on the cipher strength. In an embodiment, the network security encryption manager 156 encrypts the units of work using a key with the number of bits indicated by the cipher strength 275. In various embodiments, the network security encryption manager 156 may use a secret key, a public key, a two-part key, or any other appropriate type of key or combination thereof. In various embodiments, the network security encryption manager 156 may encrypt the units of work using the DES, AES, RSA, or ElGamal algorithms, any other appropriate algorithm, or any combination thereof.

Control then continues to block 330 where the application server 150 sends the encrypted message to the grid servers 132 in parallel. Control then continues to block 335 where at least one of the grid servers 132 decrypts the message and performs the unit or units of work, encrypts a response or responses using the same cipher strength, and sends the response or responses to the application server. Control then continues to block 340 where the application server 150 determines whether the response from the grid server 132 includes an additional request. In an embodiment, the response may include an additional request if the grid server 132 was unable to completely process a previous unit of work itself and needs the services of another grid server for an additional unit of work.

If the determination at block 340 is true, then control continues to block 345 where the network security encryption manager 156 receives the request associated with the response to the previous unit of work from the grid server 132 and determines the trust level based on the zone identifier associated with the responding grid server 132 or based on a security token from the responding grid server 132. Control then returns to block 315, as previously described above.

If the determination at block 340 is false, then control continues to block 350 where the application server 150 assembles responses from the grid servers 132 for the units of work and sends a response to the client 134 based on the assembled responses. Control then continues to block 399 where the logic of FIG. 3 returns.

In the previous detailed description of exemplary embodiments of the invention, reference was made to the accompanying drawings (where like numbers represent like elements), which form a part hereof, and in which is shown by way of illustration specific exemplary embodiments in which the invention may be practiced. These embodiments were described in sufficient detail to enable those skilled in the art to practice the invention, but other embodiments may be utilized and logical, mechanical, electrical, and other changes may be made without departing from the scope of the present invention. Different instances of the word “embodiment” as used within this specification do not necessarily refer to the same embodiment, but they may. The previous detailed description is, therefore, not to be taken in a limiting sense, and the scope of the present invention is defined only by the appended claims.

In the previous description, numerous specific details were set forth to provide a thorough understanding of embodiments of the invention. But, the invention may be practiced without these specific details. In other instances, well-known circuits, structures, and techniques have not been shown in detail in order not to obscure the invention.

What is claimed is:

1. A method comprising:
determining a cipher strength based on a trust level associated with a request;
creating a unit of work based on the request;
encrypting the unit of work into a message based on the cipher strength; and
sending the message to a plurality of grid servers.

2. The method of claim 1, further comprising:
determining the trust level based on a security token associated with the request.

3. The method of claim 1, further comprising:
determining the trust level based on a zone from which the request originates.

4. The method of claim 3, wherein the request originates from a client that belongs to the zone.

5. The method of claim 3, wherein the zone comprises at least one of the plurality of servers.

6. The method of claim 3, wherein the request originates from one of the plurality of grid servers that belongs to the zone.

7. The method of claim 6, wherein the request comprises a response from the one of the plurality of grid servers to a previous unit of work.

8. A signal-bearing medium encoded with instructions, wherein the instructions when executed comprise:
determining a cipher strength based on a trust level associated with a request;
creating a unit of work based on the request;
encrypting the unit of work into a message based on the cipher strength; and
sending the message to a plurality of grid servers.

9. The signal-bearing medium of claim 8, further comprising:
determining the trust level based on a security token associated with the request.

10. The signal-bearing medium of claim 8, further comprising:
determining the trust level based on a zone from which the request originates.

11. The signal-bearing medium of claim 10, wherein the request originates from a client that belongs to the zone.

12. The signal-bearing medium of claim 10, wherein the zone comprises at least one of the plurality of grid servers.

13. The signal-bearing medium of claim 10, wherein the request originates from one of the plurality of grid servers that belongs to the zone.

14. The signal-bearing medium of claim 13, wherein the request comprises a response from the one of the plurality of grid servers to a previous unit of work.

15. A method for configuring a computer, comprising:
configuring the computer to determine a cipher strength based on a trust level associated with a zone from which the request originates;
configuring the computer to create a unit of work based on the request;
configuring the computer to encrypt the unit of work into a message based on the cipher strength; and
configuring the computer to send the message to a plurality of grid servers.

16. The method of claim 15, further comprising:
configuring the computer to determine the trust level based on a security token associated with the request.

17. The method of claim 15, wherein the request originates from a client that belongs to the zone.

18. The method of claim 15, wherein the zone comprises at least one of the plurality of grid servers.

19. The method of claim 15, wherein the request originates from one of the plurality of grid servers that belongs to the zone.

20. The method of claim 19, wherein the request comprises a response from the one of the plurality of grid servers to a previous unit of work.
